(19) United States
(12) Patent Application Publication
(10) Pub. No.: US 2018/0055067 A1
(43) Pub. Date: Mar. 1, 2018

(54) Method for Producing Caramel Food Coloring

(71) Applicant: RedLeaf Biologics, Inc., Lexington, KY (US)

(72) Inventors: Stephen Pietsch, Dublin, CA (US); Seth DeBolt, Nicholasville, KY (US); Jiayi Yang, Millbrae, CA (US); Stefan Bauer, El Cerrita, CA (US)

(73) Assignee: RedLeaf Biologics, Inc., Lexington, KY (US)

(21) Appl. No.: 15/692,309

(22) Filed: Aug. 31, 2017

Related U.S. Application Data
(60) Provisional application No. 62/382,056, filed on Aug. 31, 2016.

(51) Int. Cl. A23G 3/32; A23L 5/43; A23L 5/20; A23L 33/105

(52) U.S. Cl. CPC A23G 3/32; A23L 5/43; A23V 2002/00; A23L 33/105; A23L 5/23

(57) ABSTRACT

A system and method for producing a caramel food colorant according to one example embodiment exhibits improved stability against precipitation and provides a rich brown color. The colorant is particularly useful for modifying the color of alcoholic beverages but has many other potential uses, including uses as an antioxidant. The novel caramel food colorant is produced from a variety of Sorghum bicolor that accumulates deoxyanthocyanidins in the leaves, and varieties that accumulate deoxyanthocyanidins in seed bran. The pigments are extracted from the leaves or bran in acidified water or a solution containing water, alcohol and acid, the pH is then adjusted to basic pH, the solution is briefly heated, then the pigment is used without further purification or purified by adsorption to a commercially available hydrophobic resin, and eluted from the resin with a solution containing water and alcohol.

### CROSS-REFERENCE TO RELATED APPLICATION

This application claims the benefit of U.S. Provisional Application No. 62/382,056, entitled “Method For Producing Caramel Food Coloring” and filed on Aug. 31, 2016, the disclosures of which are incorporated herein by reference.

### BACKGROUND

### 1. Field of the Disclosure

The present invention relates to the production of a novel pigment for use in food products. More particularly, the present invention relates to a natural food colorant for food products comprising a colorant and methods of preparing such colorants and methods of use of such colorants.

### 2. Description of the Related Art

Natural pigments are desirable colorants for certain types of foodstuffs.

A widely used current method of producing caramel coloring is the carefully controlled heat treatment of food grade carbohydrates. Food grade acids, alkalis, and salts may be employed to assist caramelization. Detailed information on caramel coloring can be found in the color additives regulations promulgated under the Federal Food, Drug and Cosmetic Act, published in Part 8, Title 21 of the Code of Federal Regulations. Caramel coloring is generally provided as an aqueous solution having an acidic pH of about 3.

While certain synthetic approved chemical colorants are permitted for use in food products, it would be desirable to have food colorants derived from edible materials.

Accordingly, it will be appreciated that systems and methods for producing a water-soluble food colorant from water-insoluble pigments extracted from the source plant material with mixtures of organic solvents and water with or without acids presents, are desired.

### SUMMARY

One aspect of the present invention resides in a novel orange-red colorant. The colorant comprises:

A colorant comprising a solution of orange-red pigments in an aqueous solution and, optionally, an acid, such as 0.1% citric acid, that is compatible with the intended food use. A relate colorant comprising a solution of water-insoluble orange-red pigments in an aqueous solution containing polyvinylpyrrolidone (PVP) and, optionally, an acid, such as 0.1% citric acid, that is compatible with the intended food use. The pigments of this invention are obtained by extracting plant materials with aqueous or alcoholic solutions that solubilize the pigments. Typically, the water-soluble pigments are extracted from leaves or bran first with an aqueous solution containing an acid with a pKa less than 3.1, then the water-insoluble pigments are extracted with an acidic ethanol solution. Mixing of the alcohol extract with a solution containing PVP results in the binding of the water-insoluble pigments to PVP which imparts water solubility to the otherwise water-insoluble pigments. The alcohol can then be removed from the mixture by evaporation, resulting in a pigment: PVP complex that is water soluble.

In one process aspect, the present invention resides in methods for preparing the present colorants. The method for preparing the colorants includes the steps of:

A. extracting leaves or leaf fragments of the RedNatural variety of Sorghum bicolor (1), or bran from certain varieties of sorghum (2), with a solution of water at a temperature of 50° C. to 121° C., but is preferentially 100° C. for 1 hour, containing a suitable acid, preferentially 100 mM hydrochloric acid, to produce a water soluble red pigment solution. Then the leaves are re-extracted with an ethanol solution, which may range from 20 to 100% ethanol, but is preferentially 70% ethanol, at a temperature which may range from 25° C. to 121° C. but is preferentially 60° C., for a time that may range from 30 minutes to 12 hours but is preferentially 4 hours.

B. The extracts are filtered through a coarse screen to remove the leaves, then filtered a second time through a filter that removes fine particles, according to the desired degree of clarity of the extract. For most purposes a screen with 0.2 mm openings is satisfactory. Heating of the extract is discontinued but forced cooling is not required.

C. A sample is taken to determine the amount of dissolved solids in the extract. A satisfactory gravimetric method is to remove all liquid by evaporation and weigh the residual solids.

The water-soluble pigment extract is typically purified by resin adsorption, as described below, then concentrated or dried before use as a food colorant or antioxidant.

D. The ethanol-soluble colorant may be used directly in applications, such as alcoholic beverages, that contain sufficient ethanol to maintain the colorant in solution. To prepare a water-soluble colorant solution, PVP is added to the ethanol extract as a dry powder or as an aqueous solution and the mixture is stirred until PVP is completely dissolved. The molecular mass of the PVP is preferably at least 40,000 daltons and preferentially more than 300,000 daltons. When 70% (v/v) ethanol is used as the extractant, the maximal amount of PVP to be added is calculated as 0.7 times the weight of dissolved solids in the volume of extract to be processed. Because of batch-to-batch variation in the amount of dissolved solids that may be extracted due to environmental variation of the crop, or the use of different concentrations of ethanol, lower ratios of PVP/dissolved solids may be possible. The maximal ratio can be determined empirically by observing the point at which addition of additional dissolved solids to a certain quantity of PVP leads to precipitation of the PVP.

Once the PVP is completely dissolved, the ethanol can be removed by evaporation. Typically, this can be accomplished by heating the extract until the ethanol is removed by evaporation. Application of vacuum can be used to reduce the amount of heat required to effect removal of ethanol. The resulting solution can be used directly as a food colorant. Current FDA regulations allow the use of PVP in foods up to a concentration of 0.1%.

In some circumstances it may be desirable to dry the pigment eluate described in claim 1 to a dry form. This may be accomplished by one of the many methods known in the art, such as evaporation, for separating non-volatile solids from water and alcohol.

### MULTIPLE EMBODIMENTS AND ALTERNATIVES

The following description illustrates embodiments sufficiently to enable those skilled in the art to practice the present invention. It is to be understood that the disclosure is not limited to the details of construction and the arrangement of components set forth in the following description. The invention is capable of other embodiments and of being practiced or of being carried out in various ways. For example, other embodiments may incorporate structural, chronological, process, and other changes. Examples merely typify possible variations. Individual components and functions are optional unless explicitly required, and the sequence of operations may vary. Portions and features of some embodiments may be included in or substituted for those of others. The scope of the application encompasses the appended claims and all available equivalents. The following description is, therefore, not to be taken in a limited sense.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

Throughout the specification and claims percentages are by weight and temperatures in degrees Centigrade unless otherwise indicated.

The orange-red colorant obtained from certain varieties of sorghum is useful in a wide variety of food coloring application to provide a desirable orange-red colorant. Other colorants may be used in combination with the colorant of this invention to produce variant colors. Additionally, this orange-red colorant may be converted to a caramel colorant by a simple process described herein.

Method of Preparation

In its method aspect, the present invention resides in methods for preparing water-soluble colorants for foodstuffs, including certain beverages. Because of the high molecular weight of the PVP, the colorant diffuses slowly, which may be useful for certain applications in which bleeding of the colorant is undesirable.

A preferred starting material for the present methods is a non-GMO variety of sorghum called RedNatural that has not previously been available (1). This variety accumulates 3-deoxyanthocyanidin pigments in the leaves. These pigments have not previously been available in commercial quantities but have been studied by academic scientists because they accumulate in the tissues surrounding the sorghum seed in other varieties of sorghum. A second source of starting material is the bran of certain varieties of sorghum (2). The bran is produced as a byproduct of sorghum seed production.

In the present method, leaves of the RedNatural sorghum variety are harvested at a time during the growth cycle that maximizes the yield of pigment. The leaves may be extracted immediately or dried by air drying or by a variety of methods known to those skilled in the art of drying plant leaf material. For example, the tobacco industry typically harvests fresh leaves and dries the leaves by passive air-drying methods or in mechanical dryers that used heat and forced air to accelerate drying.

After drying the leaves are mechanically cut using devices such as hammer mills. Typically, the leaf is cut to fragments with an average size of about 0.5 inch in diameter or less to facilitate handling. However, there is no lower or upper limit to an acceptable size for the extraction process. The size of the leaf fragments does not have a major impact on the extraction process.

The leaf fragments are placed in an extractant solution to extract the colored pigments. Pigment is extracted over a wide range of ratios of leaf dry weight to extractant. Low ratios (e.g., 1 liter of extractant per kg leaf mass) of extractant to leaf lead to concentrated solutions of pigment and high ratios (e.g., 20 liters of extractant per kg of leaf mass) lead to dilute solutions of pigment. However, low ratios of extractant to leaf mass lead to poor recovery of the desired colorant because of technical difficulties in recovering all of the extractant/colorant solution. High ratios of extractant to leaf mass lead to dilute solutions of colorant. Thus, a preferred ratio of extractant to leaf mass dry weight is 12 volumes of extractant per weight of leaf mass (e.g., 12 liters of extractant per kg of dry leaf mass).

Because the pigments that comprise the colorants of this invention are soluble in many solvents or solvent water compositions, the composition of the extractant can vary significantly without substantially altering the core invention disclosed herein. Because of the optional purification step, which allows complete removal of solvents, it is possible that various solvents might be used for the extraction step. Thus, the examples provided herein are intended to illustrate the principles of the invention rather than to limit the invention to any specific extractant composition.

Some of the colored pigments of this invention are soluble in aqueous solutions and are typically recovered by aqueous extraction. Additionally, some the colored pigments of this invention are particularly soluble in alcohols, and in view of the fact that ethanol has low toxicity when used in low amounts in food, the most preferred extractant for these pigments is a mixture of ethanol and water. Various ratios from 20% ethanol to 99.5% ethanol can be used in the extractant. However, the preferred extractant is 70% ethanol and 30% water containing a suitable acid. The acid component of the extractant serves to maintain a partial charge on the 3-deoxyanthocyanidin pigments present in the RedNatural leaf material, or in the seed bran. Many acids are suitable (e.g., hydrochloric acid, sulfuric acid, phosphoric acid, citric acid). Indeed, we believe that any acid with a pKa of less than about 3.1 that is soluble in the water:ethanol mixture and is compatible with food uses would be suitable. The preferred acid is 100 mM hydrochloric acid, however other mineral and organic acids are also satisfactory.

After mixing the leaf fragments and the extractant, the temperature of the reactor is raised to facilitate the extraction of pigments. Any temperature in the range of about 20° C. to 121° C. is suitable for extracting the pigments that are the basis of this invention. The optimal temperature for extraction of the water-soluble pigments in sorghum leaves is in the range of 60-100° C. The optimal temperature for extraction of the water-insoluble pigments in sorghum leaves is 60° C. Stirring of the slurry facilitates the extractive process and the temperature of the extractor is typically maintained at the desired temperature during the extractive process. The duration of extraction is not critical. Short extractions of about 30 minutes can produce significant amounts of pigment. Long extractions of up to 12 hours at lower temperatures result in the maximum amount of pigment being extracted. However, the rate of extraction tends to follow an asymptotic curve and relatively short extractions typically make the best use of capital investments and operating costs. In the exemplary case of an extractant composed of 70% ethanol, 100 mM hydrochloric acid an extraction time of 1 hour was found to produce an acceptable balance between maximal recovery of pigment and capital and operating costs associated with the extraction. Similarly, for recovery of soluble pigments, an aqueous solution of 100 mM HCl at 100° C. for 1 h is optimal.

Following extraction of the pigments, the reactor is cooled to approximately room temperature and the leaf fragments are separated from the extract by filtration on a coarse screen. Subsequently, the fines are removed by a second filtration step in which the filtered extract is forced through a filter that removes fines down to a predetermined size. Such filtration systems are known to those skilled in the art. The choice of filter depends on the proposed application for the product. The use of the colorant in liquids such as alcoholic beverages may require filters on the 1 micron scale. Other applications, such as an insoluble colorant on cereal may not require any fine filtration.

At this stage of the process, both the aqueous and ethanolic extracts have an attractive orange-red color. The total extract contains a wide variety of compounds that are derived from compounds present in the sorghum leaf at the time the extraction process was initiated. Typically, the compounds present in the total extract will not have any taste or other qualities that interfere with the use of the total extract as a food colorant.

Evaporation of the solvent from the extract at this stage results in a pigment preparation that contains a certain amount of dissolved solids. The amount of dissolved solids can be measured by drying a known volume of the extract and weighing the residue. However, a significant proportion of the dissolved solids in an ethanol solution will be insoluble in aqueous solutions that do not contain PVP or another suitable excipient. In order to bring the water-insoluble pigments into aqueous solution, PVP with a molecular weight of greater than 40,000 daltons is added to the extract. The amount of PVP used should be 1 kg of PVP per 1.5 kg of dissolved solids in the ethanol extract.

For some potential applications of the pigments present in the RedNatural variety of sorghum, or in certain sorghum brans, it may be desirable to separate water-soluble and water-insoluble pigments at the extraction stage. In this case the first step in preparing pigments is to extract the leaves with an aqueous solution containing a small amount of an acid with a pKa below pH 3.1 such as hydrochloric acid, sulfuric acid, or any other water-miscible acid with a suitable pKa that is compatible with the intended use. Typically, the acid is present at a concentration of 0.1% (w/v) though higher concentrations up to about 5% (w/v) are suitable for some purposes. To extract water-soluble pigments, leaves are immersed in acidified water, such as 0.1% sulfuric acid or 0.1% hydrochloric acid at a liquid to solid ratio of at least 7 and preferably at least 15 to 20, for 1 h at 60-100° C. , and then the leaves are separated from the aqueous solution by filtration. To obtain water-insoluble pigments, the water-extracted leaves are re-extracted with an ethanol solution, as described above. Thus, two red colored solutions are obtained as primary extracts, an aqueous extract and an ethanolic extract. Both types of extracts may be used as colorants or antioxidants as is, or after further purification and concentration, or after addition of certain carriers such as PVP.

The conversion of the red color to caramel color is carried out by adjusting the pH of the extract to a basic pH through the addition of a base such as sodium hydroxide or potassium hydroxide. The conversion may be carried out on the primary extracts, or after further purification of pigments. Other bases are suitable for the conversion but some, such as ammonia or ammonium hydroxide, may confer undesirable taste elements to the final product. Any pH in the range of 8.0 to 10.0 is suitable. However, a preferred pH is 8.0. Following adjustment of the pH, the extract is heated to accelerate the conversion of the red color to a brown color. A specific temperature is not critical. Any temperature between 50° C. and 121° C. is suitable. However, a temperature of 60° C. is preferred at pH 8.0. The optimal time of incubation at the elevated temperature is related to the pH. At pH 8.0, and a temperature of 60° C. an optimal temperature and time for the conversion of the pigment is 1 hour. At pH 8.0 and incubation temperature of 100° C., a shorter period of incubation, 30 minutes, is sufficient. The time and temperature of the treatment can be determined visually by inspecting the conversion of the red pigment to a brown pigment of a desired hue throughout the process. For some applications a balance of red and brown hues may be desirable.

When the color of the extract has achieved the desired brown color, the extract is cooled, the pH is adjusted to an acidic pH to stabilize the pigments, typically in the range of pH 3 to 6, depending on the intended use. and may be used as a food colorant or antioxidants at that point. When produced from a primary extract, this colorant is designated as total extract. The total extract contains a wide variety of compounds that are derived from compounds present in the sorghum leaf at the time the extraction process was initiated. The aqueous extract has a complex composition, whereas the ethanol extract of water-extracted leaves has a relatively simple composition. Typically, the compounds present in the total extract will not have any taste or other qualities that interfere with the use of the total extract as a food colorant. However, for some applications, a more purified preparation may be desirable.

Purified colorants can be obtained from the total extract by adsorption to a hydrophobic resin, such as SP700 available from the Diaion subsidiary of Mitsubishi. Water-soluble red pigments or caramel pigments can also be purified from aqueous or ethanol extracts of sorghum leaves by the same method. Many other resins with similar properties are available and may be used as alternatives to the SP700 resin. Examples of other suitable resins include Amberlite XAD18, Amberlite FPX66, Dowex Optipore L493 and Diaion SP70 and many others with similar properties. To carry out the purification, the total extract, at approximately room temperature, is diluted with water, if necessary, until the alcohol content is less than 25% (volume/volume), then applied to a bed of a suitable resin such as SP700 resin (Sepabeads). The interaction of the total extract and the SP700 beads can be in a stirred batch mode in which the resin and the total extract are stirred. Alternatively, the interaction may take place in a column format in which the extract is applied to a column containing the resin and slowly pumped onto the column. Following adsorption of the pigments to the resin, the resin bed is washed extensively with water, preferentially at least three bed volumes, until the conductivity of the eluate indicates that low or no amounts of ions are being washed from the resin. Then the pigment is eluted with ethanol, preferentially about two bed volumes of 80-90% ethanol to produce the purified extract. The purified extracts can be used directly as colorants or concentrated or dried before use.

The following examples further illustrate the implementation of this invention.

### Example 1

Dried leaves of the RedNatural variety of Sorghum bicolor were cut in a hammer mill to an average diameter of 0.5 cm. One hundred grams of the dried leaves were stirred into 1.2 liters of 70% ethanol containing 100 mM (final concentration) of hydrochloric acid. The slurry was heated at 60° C. for 4 hours with intermittent stirring (stirred with a small paddle at 15 minutes intervals).

Following the extraction, and cooling to room temperature, the extract was filtered through two layers of Miracloth (Calbiochem). The extract so obtained was then filtered through a 1.2 micron filter. The extract was then adjusted to pH 8.0 with 5 M sodium hydroxide and heated to 60° C. for 1 h, during which time the extract changed from a red solution to a brown solution. The extract was cooled to room temperature, the pH was adjusted to pH 4, and used to color a solution of 45% alcohol in water a caramel color that resembled bourbon. The color was stable for extended periods of time.

### Example 2

The preparation of the extract was identical to that described in example 1. However, instead of using the colorant directly, the extract (called total extract) was purified on SP700 resin. The volume of extract was measured and water was added to bring the alcohol concentration to 25% (vol/vol). The extract was placed in a 4 liter beaker with a magnetic stir bar and 500 grams of SP700 resin was added. The resin was washed before use according to instructions provided by the manufacturer. The slurry of beads and extract was stirred for 1 hour at room temperature and then the beads were collected on a filter in a Buchner funnel. The beads were washed with water by pouring three volumes of water on the resin bed and then pulling the water through the bed under vacuum. The caramel colorant was eluted from the resin by passing two bed volumes of 95% ethanol through the resin bed. The resulting purified caramel extract was used to impart caramel color to alcoholic solutions as described in example 1.

### Example 3

The preparation and use of the extract was identical to that described in Example 2 except methanol containing 100 mM hydrochloric acid was used as the extractant. The methanol was removed by washing the resin bed with five volumes of water.

### Example 4

Dried leaves of the RedNatural variety of Sorghum bicolor were cut in a hammer mill to an average diameter of 0.5 cm. One hundred grams of the dried leaves were stirred into 1.2 liters of water containing 0.1% sulfuric acid. The slurry was heated at 100° C. for 1 hour with intermittent stirring (stirred with a small paddle at 15 minutes intervals).

Following the extraction, and cooling to room temperature, the extract was filtered through two layers of Miracloth (Calbiochem), then applied to a chromatography column 3 cm diameter×12 cm high containing a bed of SP700 resin 8.5 cm in height. The resin had previously been prepared according to the manufacturers instructions and equilibrated with 0.1% sulfuric acid in water. Following adsorption of the pigments to the resin, the resin bed was washed with 3 volumes of water, then the pigments eluted with two bed volumes of 85% ethanol. The ethanol was removed by evaporation and the resulting concentrate lyophilized. The result was a free flowing red powder that is useful as a food colorant and antioxidant.

### Example 5

The preparation of the extract was identical to that described in Example 4 except that the temperature of the extraction was 121° C. and the extraction was done under 1.06 bars of pressure.

### Example 5

An extract was prepared as described in Example 2. The Trolox equivalent value of the extract, a measure of the antioxidant properties of the extract was found to be 240,000 Trolox equivalents per 100 g of solids, determined by gravimetric analysis of the total extract. The extract was used as an antioxidant in feed and food preparations.

### REFERENCES

1. Petti, C., Kushwaha, R., Tateno, M, Harman-Ware, A. E., Crocker, M., Awika, J., DeBolt, S. (2014) Mutagenesis Breeding for Increased 3-Deoxyanthocyanidin Accumulation in Leaves of Sorghum bicolor (L.) Moench: A Source of Natural Food Pigment. J. Agric. Food Chem. 2014 62 (6), 1227-1232

2. Awika, J. M., McDonough, C. M., Rooney, L. W. (2005) Decorticating Sorghum to Concentrate Healthy Phytochemicals. J. Agric. Food Chem. 53 (16), 6230-6234

The foregoing description of several embodiments has been presented for purposes of illustration. It is not intended to be exhaustive or to limit the application to the precise forms disclosed, and obviously many modifications and variations are possible in light of the above teaching. It is understood that the invention may be practiced in ways other than as specifically set forth herein without departing from the scope of the invention.

What is claimed is:

1. A system for producing a caramel colorant, comprising:
extracts of sorghum plant tissues wherein the extracts have a pH below pH 3.1,
a first filtering of the extracts to remove insoluble materials,
a second filtering of the extracts to remove fine particles,
a first adjustment of the pH of the extracts to a basic pH range between 8 and 10,
a heating of the extracts to a temperature between 60 and 100° C. for 30 minutes to 4 hours;
a cooling of the extracts to room temperature; and
a second adjustment of the pH of the extracts to an acidic pH range between 3 and 6.

2. The system of claim 1, wherein the colorant is further purified before use.

3. The system of claim 1, wherein the colorant is converted to a dry form.

4. The system of claim 2, wherein the colorant is converted to a dry form.

5. The system of claim 1, 2, 3 or 4 wherein the sorghum plant tissues contain high levels of deoxyanthocyanidins.

6. A method for using the colorant from claim 1 as an antioxidant.
